(19) United States
(12) Patent Application Publication
(10) Pub. No.: US 2009/0263634 A1
(43) Pub. Date: Oct. 22, 2009

(54) Magnetic Wallpaper Systems

(75) Inventors: Jeremy W. Hyer, Parkersburg, WV (US); Jason T. Sargent, Belpre, OH (US)

Correspondence Address: Stoneman Volk Patent Group, 3770 NORTH 7TH STREET, Suite 100, PHOENIX, AZ, 85014, US

(73) Assignee: MAGNUM MAGNETICS CORPORATION, Marietta, OH (US)

(21) Appl. No.: 12/421,515

(22) Filed: Apr. 9, 2009

Related U.S. Application Data
(60) Provisional application No. 61/046,374, filed on Apr. 18, 2008.

(51) Int. Cl. B32B 9/04; E04F 13/07

(52) U.S. Cl. 428/195.1; 156/71; 428/411.1

(57) ABSTRACT

A magnetic wallpaper system designed to easily install and remove wallpaper without damaging either the wallpaper or the surface of the wall. Such magnetic wallpaper may be printed for personally customized designs or images. Also such magnetic wallpaper may be printed to reflect a season, holiday, event, etc., and be easily changed according to the desired theme for a room.

### CROSS-REFERENCE TO RELATED APPLICATION

The present application is related to and claims priority from prior provisional application Ser. No. 61/046,374, filed Apr. 18, 2008, entitled “MAGNETIC WALLPAPER SYSTEMS”, the content of which is incorporated herein by this reference and is not admitted to be prior art with respect to the present invention by the mention in this cross-reference section.

### BACKGROUND

This invention relates to magnetic wallpaper systems. More particularly, this invention relates to providing a magnetic wallpaper system comprising reusable wallpaper. Also, this invention relates to providing a system comprising magnetically attachable wallpaper making such magnetically attachable wallpaper easy to install and remove.

Conventional adhesive wallpaper is single-use. Conventional wallpaper is un-useable after it has been removed and must be discarded. The inability to re-use wallpaper limits wallpaper-customization of walls and other surfaces which might be covered by wallpaper. Wallpaper installation, likewise, is made more difficult since once placed it is difficult to move, even slightly, for example to align a wallpaper pattern. In addition to the above, water-activated adhesive wallpaper installation is messy and requires purchase of adhesive, rollers, blades, etc.

No system exists that overcomes the above problems, provides wallpaper reusability and the ability to align and realign wallpaper, and does not require the purchase of adhesive, rollers, blades, etc.

Therefore, a need exists for a wallpaper system overcoming the above-mentioned needs that is easy to install, modify, and customize.

### OBJECTS AND FEATURES OF THE INVENTION

A primary object and feature of the present invention is to provide a magnetic wallpaper system overcoming the above-mentioned problems.

It is a further object and feature of the present invention to provide such a magnetic wallpaper system that may be moved from one location to another.

It is a further object and feature of the present invention to provide a wallpaper system that may be installed without wetting the wallpaper.

It is a further object and feature of the present invention to provide a wallpaper system that may be installed without wetting, or applying a wet adhesive.

Another object and feature of the present invention is to provide such a magnetic wallpaper system that is easy to install, remove, adjust, align, realign, etc., without damage to the wallpaper or to the wallpaper-applied wall.

A further object and feature of the present invention is to provide a method to custom print patterns, images, graphics, photos, etc., on magnetic wallpaper.

Yet another object and feature of the present invention is to provide themed magnetic wallpaper that may be easily “swapped” with prior-installed magnetic wallpaper to quickly alter a room to a desired theme.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a method, relating to covering building walls and related essentially flat surfaces using rolls of flexible wall-coverings, comprising the steps of: unrolling and cutting strips of such wall-coverings; securely attaching such cut strips, in a non-wetted condition, to respective portions of surfaces to be covered; wherein such strips may be unattached from such surfaces without harm to such strips and such surfaces. Moreover, it provides such a method, wherein such attached strips may be moved after being so unattached and re-used on another such surfaces. Additionally, it provides such a method, further comprising the step of magnetically preparing respective portions of surfaces to be covered with magnetic paint; wherein such strips of such wall-coverings comprise at least one magnetic material. Also, it provides such a method, further comprising the step of magnetically preparing respective portions of surfaces to be covered with magnetic paint; wherein such strips of such wall-coverings comprise at least one magnetic material.

In accordance with another preferred embodiment hereof, this invention provides a method, relating to covering building walls and related essentially flat surfaces, comprising the step(s) of: providing at least one plurality of adjoinable, flexible, wall-covering strips; and securely attaching, in an adjoining relation, at least two such wall-covering strips, in a non-wetted condition, to respective portions of surfaces to be covered. In addition, it provides such a method, further comprising the step(s) of removing such at least two such wall-covering strips, also in a non-wetted condition without harm to such at least two wall-covering strips and such surfaces. And, it provides such a method, further comprising the step of magnetically preparing respective portions of surfaces to be covered with magnetic paint; wherein such wall-covering strips comprise at least one magnetic material. Further, it provides such a method, further comprising the step of magnetically preparing respective portions of surfaces to be covered with magnetic paint; wherein such wall-covering strips comprise at least one magnetic material.

In accordance with another preferred embodiment hereof, this invention provides a method, relating to covering building walls and related essentially flat surfaces, comprising the steps of: providing magnetically preparing respective portions of surfaces to be covered; providing at least one plurality of magnetic, flexible, wall-covering strips wherein such strips may be magnetically attached to such surfaces to be covered; and securely attaching, in an adjoining relation, at least two such wall-covering strips, in a non-wetted condition, to respective portions of surfaces to be covered.

In accordance with another preferred embodiment hereof, this invention provides a wall-covering system, relating to covering at least one portion of at least one wall, such system comprising: at least one plurality of flexible-material, wall-covering strips adjoined to cover at least one substantial portion of such at least one wall; and at least one releasable attachment system positioned immediately adjacent such at least one substantial portion of such at least one wall; wherein such releasable attachment system is structured and arranged to permit non-destructive removal of such wall-covering strips from such at least one portion of such at least one wall. Even further, it provides such a wall-covering system, wherein such removed wall-covering strips are structured and arranged to be re-used. Moreover, it provides such a wall-covering system, wherein such wall-covering strips comprise at least one printable surface. Additionally, it provides such a wall-covering system, wherein such at least one printable surface comprises printed photography. Also, it provides such a wall-covering system, wherein such at least one printable surface comprises printed art.

In addition, it provides such a wall-covering system, wherein such at least one printable surface comprises at least one portion of at least one serial theme. And, it provides such a wall-covering system, wherein such at least one serial theme relates to at least one of the group comprising: at least one convention; at least one holiday; at least one season; at least one celebration; at least one event; at least one honoring of at least one individual; at least one honoring of at least one relationship; at least one educational theme; and at least one advertisement. Further, it provides such a wall-covering system, wherein such at least one wall-covering is attachable to at least one magnetically prepared wall. Even further, it provides such a wall-covering system, wherein such at least one wall cover is cut from a roll of flexible material. Moreover, it provides such a wall-covering system, further comprising the at least one portion of at least one wall; wherein such at least one portion of at least one wall is covered using wall-coverings comprising at least one printed surface; such printed surface comprising at least one portion of at least one serial theme.

In accordance with another preferred embodiment hereof, this invention provides a method of wallpapering at least one portion of at least one wall comprising the step(s) of: providing materials to magnetically prepare such at least one portion of at least one wall; providing at least one wall cover comprising at least one releasable attachment system to attach such at least one wall cover to such magnetically prepared at least one portion of at least one wall; attaching such at least one wall cover to such at least one magnetically prepared at least one portion of at least one wall. Additionally, it provides such a method, wherein the step of providing at least one wall cover comprises the step(s) of providing selecting at least one image to be printed on such at least one wall cover. Also, it provides such a method, wherein the step of providing at least one wall cover further comprises the step(s) of providing assisting renting such at least one wall cover. In addition, it provides such a method, wherein the step of providing selecting at least one image to be printed on such at least one wall cover comprises the step(s) of providing assisting printing at least one advertisement on such at least one wall cover.

In accordance with another preferred embodiment hereof, this invention provides a wall-covering system, relating to covering at least one portion of at least one wall, such system comprising: wall-covering means for substantially covering at least one portion of at least one wall; wherein such wall-covering means comprises attaching means for attaching such wall-covering means to such at least one portion of at least one wall; wherein such attaching means comprises releaser means for releasing such wall-covering means from such at least one portion of at least one wall; and wherein such attaching means are substantially retained even after such wall-covering means is released from such at least one portion of at least one wall.

In accordance with another preferred embodiment hereof, this invention provides a wall-covering system, relating to covering at least one portion of at least one wall, such system comprising: at least one wall cover to cover at least one portion of at least one wall; wherein such at least one wall cover comprises at least one attacher to attach such wall cover to such at least one portion of at least one wall; wherein such attacher comprises at least one releaser to release such wall cover from such at least one portion of at least one wall; and wherein such attacher is substantially retained even after such wall cover is released from such at least one portion of at least one wall. And, it provides such a method, wherein such wall-covering comprises at least one printable surface.

Further, it provides such a method, wherein such at least one printable surface comprises printed photography. Even further, it provides such a method, wherein such at least one printable surface comprises printed art. Even further, it provides such a method, wherein such at least one printable surface comprises at least one portion of at least one serial theme. Even further, it provides such a method, wherein such at least one serial theme relates to at least one of the group comprising: at least one convention; at least one holiday; at least one season; at least one celebration; at least one event; at least one honoring of at least one individual; at least one honoring of at least one relationship; at least one educational theme; and at least one advertisement. Even further, it provides such a system, wherein such flexible-material, wall-covering strips comprise at least one sheet magnet layer less than about 20 mil. Even further, it provides such a system, wherein such flexible-material, wall-covering strips comprise at least one sheet magnet layer less than about 15 mil in thickness.

Lastly, this invention provides a magnetic wallpaper system comprising each and every novel feature, element, combination, step and/or method disclosed or suggested by this patent application.

### BRIEF DESCRIPTION OF THE DRAWINGS

FIG. 1 shows a perspective view, illustrating a room in a structure with a preferred magnetic wallpaper system installed, according to the preferred embodiment of the present invention.

FIG. 2 shows a front view of a wall with the magnetic wallpaper system installed, illustrating printed images, according to the preferred embodiment of FIG. 1.

FIG. 3 shows a perspective view illustrating a roll of a magnetic wallpaper strip according to the preferred embodiment of FIG. 1.

FIG. 4 shows the enlarged sectional view 4-4 of FIG. 2 of a preferred magnetic wallpaper strip installed on a wall, illustrating a preferred magnetic attractive force, according to the preferred embodiment of FIG. 2.

FIG. 5 shows the sectional view 5-5 of FIG. 2 of magnetic wallpaper strip installed on the wall, illustrating a magnetic wallpaper installation system, according to the preferred embodiment of FIG. 2.

FIG. 6 shows a diagrammatic view illustrating a preferred magnetic wallpaper wholesale supply system, comprising magnetic wallpaper product flow to a retail distributer, according to a preferred embodiment of the present invention.

FIG. 7 shows a diagrammatic view illustrating a preferred magnetic wallpaper retail sales system, comprising retail distribution to at least one customer, according to a preferred embodiment of the present invention.

FIG. 8 shows a diagrammatic view illustrating a preferred magnetic wallpaper product and services system, comprising professional services interaction with product flow, according to a preferred embodiment of the present invention.

FIG. 9 shows a diagrammatic view illustrating a preferred magnetic wallpaper professional services system, illustrating contracted professional services, according to a preferred embodiment of the present invention.

FIG. 10 shows a diagrammatic view illustrating a preferred magnetic wallpaper rotation system, comprising wall covering rotation services, according to a preferred embodiment of the present invention.

FIG. 11 shows a diagrammatic view illustrating a preferred magnetic wallpaper licensing agreement system according to a preferred embodiment of the present invention.

FIG. 12 shows a diagrammatic view illustrating a preferred magnetic wallpaper data processing system, illustrating processing and reporting of sales data, according to a preferred embodiment of the present invention.

FIG. 13 shows a diagrammatic view illustrating a preferred magnetic wallpaper information exchange system, illustrating messaging and exchange of sales data, according to a preferred embodiment of the present invention.

### DETAILED DESCRIPTION OF THE BEST MODES AND PREFERRED EMBODIMENTS OF THE INVENTION

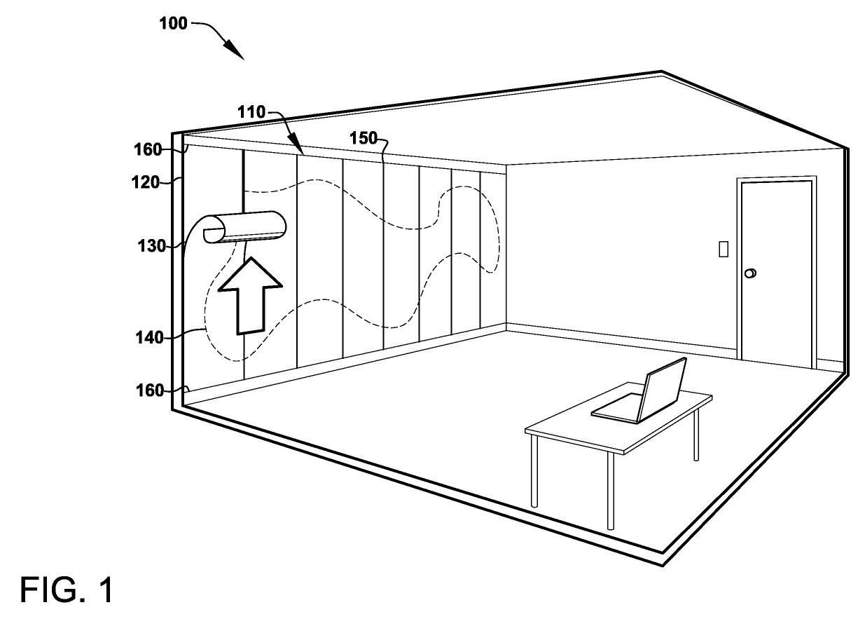

FIG. 1 shows a perspective view, illustrating a room in a structure with a preferred magnetic wallpaper system 100 installed, according to a preferred embodiment of the present invention. Magnetic wallpaper system 100 preferably comprises at least one magnetic wall covering 110, as shown, capable of substantially covering at least one portion of at least one wall 120. Magnetic wall covering 110 preferably comprises at least one printed image 140 printed on a printable surface of magnetic wall covering 110, as shown (printed image 140 is shown as an amorphous shape and in dotted lines to illustrate that any size and shape of printed image may potentially be printed on wall covering 110; conventional wallpaper typically displays a pattern). Magnetic wall covering 110 preferably comprises at least one magnetic wallpaper strip 130, as shown. Magnetic wallpaper strip 130 is preferably between about 20 inches and about 27 inches in width, preferably about 24 inches. Magnetic wallpaper strip 130 preferably may be provided in portions (pre-sized) or in rolls. Upon reading this specification, those with ordinary skill in the art will now appreciate that, under appropriate circumstances, considering such issues as design preference, user preferences, marketing preferences, cost, structural requirements, available materials, technological advances, etc., other size arrangements such as, for example, pre-sizes to fit certain magnetic surfaces, lockers, doors, electrical panels, window frames, etc., may suffice.

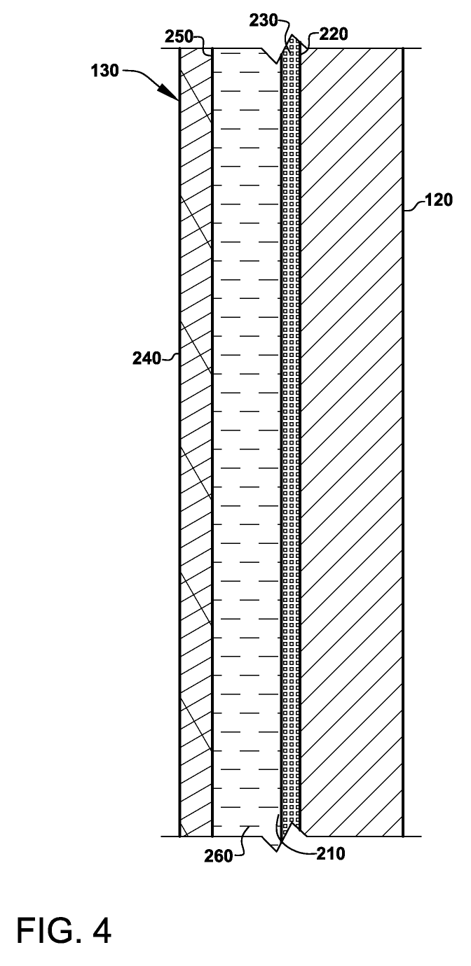

Magnetic wallpaper strip 130 is preferably removable and preferably reusable. Magnetic wallpaper strip 130 is installed preferably by application directly onto wall 120, preferably by unrolling. Magnetic wallpaper strip 130 is also preferably attachable to wall 120 in a non-wetted condition. At least one magnetically-attractive paint 220, as shown in FIG. 4, preferably is used to prepare wall 120 so as to form at least one magnetic attractive force 210 between wall 120 and magnetic wallpaper strip 130. Magnetically-attractive paint 220 preferably comprises paint mixed with ferrous materials, preferably comprising about 14 pounds (lbs) of such ferrous materials per gallon of paint (commercially available under the brand name “Active Wall” supplied or distributed by Magnamagic of Mendon, Mass. Magnetic wallpaper strip 130 (at least embodying herein at least one wall cover to cover at least one portion of at least one wall) preferably is installed dry without any chemical preparation, providing a clear advantage over conventional wallpaper application. Upon reading this specification, those with ordinary skill in the art will now appreciate that, under appropriate circumstances, considering such issues as design preference, user preferences, marketing preferences, cost, structural requirements, available materials, technological advances, etc., other wall covering arrangements such as, for example, such as covers with erasable (such as dry-erase), external surfaces with magnetic internal surfaces adapted to cover small walls, metal locker walls, and including sheets, strips, rolls, etc., may suffice.

Adjustments in position to magnetic wallpaper strip 130 preferably may be made, allowing minimization of at least one seam 150 between two adjacent magnetic wallpaper strips 130 while preferably also allowing alignment of portions of printed image 140 spanning at least one seam 150, as shown. Magnetic wallpaper strip 130 preferably adheres to wall 120 preferably using magnetic attractive force 210, as shown in FIG. 4. Magnetic attractive force 210 preferably allows adjustments to position during installation. At least one molding strip 160 is preferably installed on at least one edge 170 of magnetic wall covering 110, as shown.

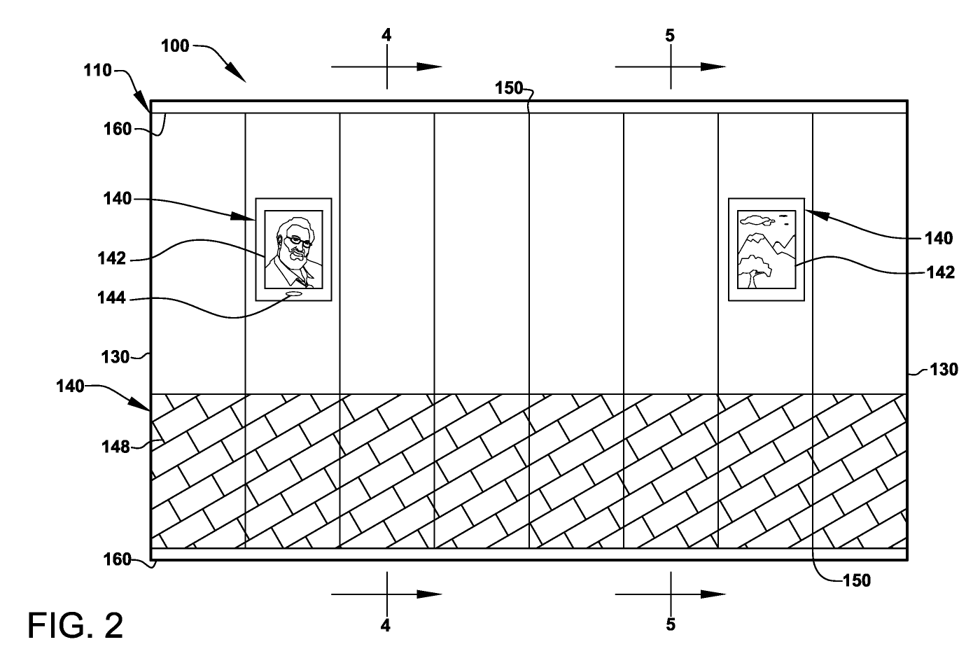

FIG. 2 shows a front view of a wall with preferred magnetic wallpaper system 100 installed, illustrating printed images 140, according to the preferred embodiment of FIG. 1. Printed image 140 preferably comprises at least one indicia 144, alternately preferably at least one photo 142, alternately preferably at least one graphic art 146, alternately preferably at least one pattern 148. FIG. 2 illustrates the ability to place a photograph or graphic image directly on installed wallpaper without nailing or hanging a picture frame on the wallpaper. Upon reading the teachings of this specification, those of ordinary skill in the art will now appreciate that, under appropriate circumstances, considering such issues as user preference, intended use, etc., other printed images, such as photographs provided to a printer for placement on a magnetic wallpaper strip to achieve a personalized look by uploading an image to a web site fulfilled by delivery of the personalized wallpaper strip, murals, artist-licensed murals, user-provided patterns, etc., may suffice.

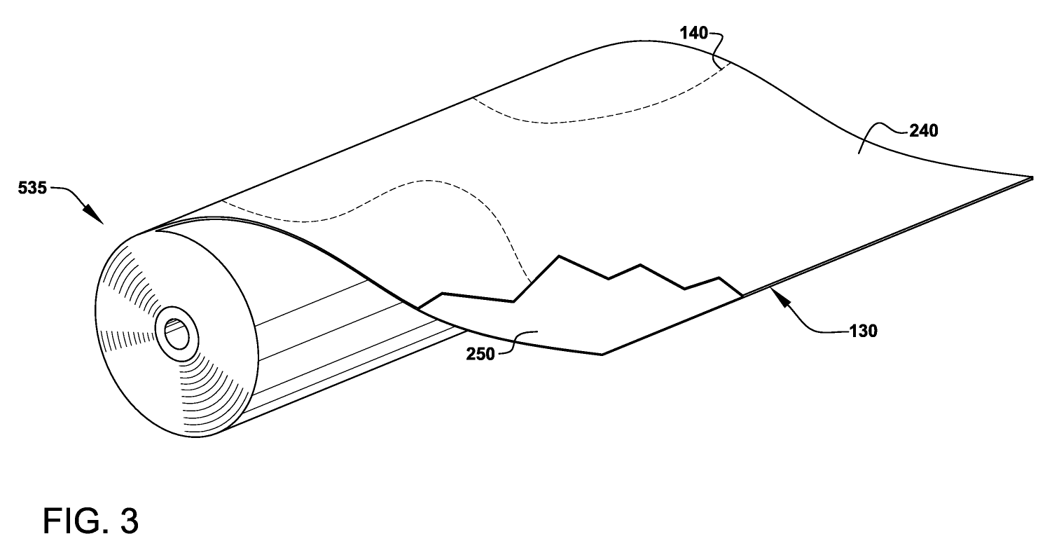

FIG. 3 shows a perspective view illustrating at least one roll 535 of magnetic wallpaper strip 130 according to the preferred embodiment of FIG. 1. As shown, magnetic wallpaper strip 130 preferably comprises at least one sheet magnet layer 250 and preferably at least one printable film 240 adhered together. Printable film 240 preferably comprises at least one polymer, preferably polyvinyl. Sheet magnet layer 250 preferably is less than about 20 mil (about 0.02 inch) in thickness, preferably less than about 15 mil in thickness.

FIG. 4 shows an enlarged sectional view through section 4-4 of FIG. 1 of magnetic wallpaper strip 130 installed on wall 120, illustrating magnetic attractive force 210, according to the preferred embodiment of FIG. 2. Wall 120 preferably is coated with at least one magnetically-attractive paint 220, as shown. Magnetically-attractive paint 220 preferably comprises at least one paint, preferably laced with magnetically-attractive particles 230, as shown, preferably ferrous particles. Sheet magnet layer 250 preferably produces a magnetic field (such layer at least embodying herein attaching means for attaching said wall-covering means to such at least one portion of at least one wall and at least embodying herein releaser means for releasing said wall-covering means from such at least one portion of at least one wall) which attracts such magnetically-attractive particles 230 creating a magnetic attractive force 210, as shown, preferably sufficient to magnetically adhere magnetic wallpaper strip 130 to wall 120. The magnetic field strength, and thus magnetic attractive force 210, depends on the amount and magnetic strength of magnetic crystals 260 contained within sheet magnet layer 250. Increasing either the number of magnetic crystals 260 or the magnetic strength of such magnetic crystals 260 directly increases the magnetic field strength of sheet magnet layer 250. Increasing the density of magnetic crystals 260 too high, however, also makes sheet magnet layer 250 brittle, so in order to increase the number of magnetic crystals 260, the thickness of magnetic sheet layer also increases. However, using magnetic crystals 260 comprising higher energy increases the magnetic field strength produced without increasing the thickness. Preferably, sheet magnet layer 250 comprises magnetic crystals 260, preferably high-energy magnetic crystals, allowing weight of magnetic wallpaper strip 130 to be minimal from thickness. In the industry, the term “high-energy”, when applied to magnetic sheet products, relates to a significant increase in magnetic field per volume of magnetic material over “standard energy”, and is often more powerful than “standard energy” by about two times or more. Additionally, when relating to strontium ferrite, the ball-milling process requires a significant increase in kinetic energy to break up the crystalline structures of the strontium ferrite into a finer powder, which allows a higher magnetic field per volume than used in “standard energy”. Magnetic attractive force 210 will preferably be greater than the gravitational force pulling magnetic wallpaper strip 130 away from wall 120. Printed image 140 is preferably printed on printable film 240 prior to installation of magnetic wallpaper strip 130. Preferably, wall covering 110 may be customized to at least one desired location in both size and printed image 140, as indicated in discussion of FIG. 1.

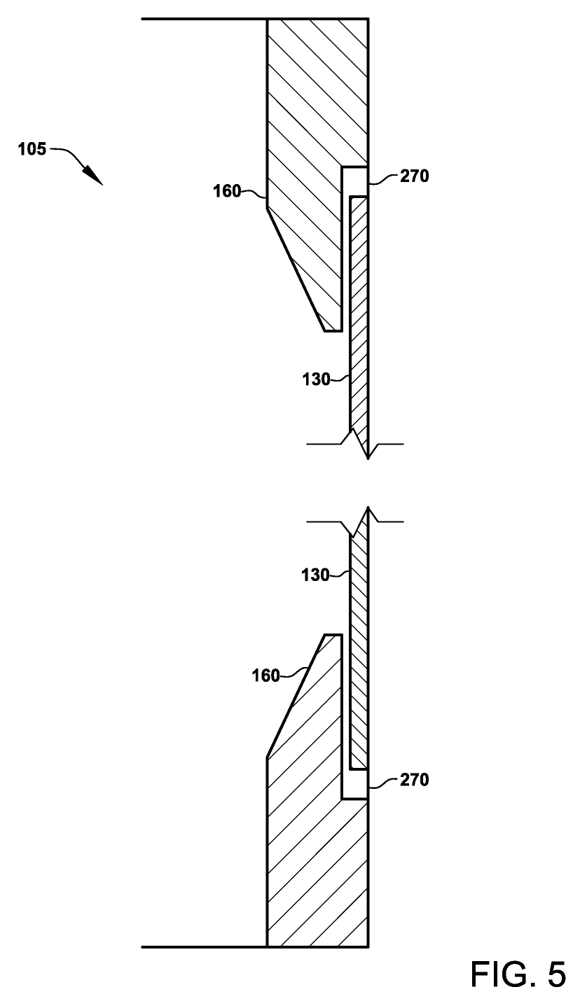

FIG. 5 shows a sectional view through section 5-5 of FIG. 2 of magnetic wallpaper strip 130 installed on wall 120, illustrating a magnetic wallpaper installation system 105, according to the preferred embodiment of FIG. 2. Magnetic wallpaper installation system 105 preferably comprises at least one molding strip 160, as shown. Molding strip 160 preferably covers at least one gap 270, as shown, created by difference between length of magnetic wallpaper strip 130 and size of wall 120 preferably allowing for alignment of portions of printed image 140. Preferably, molding strip 160 is installed prior to magnetic wallpaper strip 130 allowing installation and removal of magnetic wallpaper strip 130. Preferably molding strip 160 attaches to wall 120, preferably with nails, alternately preferably with glue. Gap 270 preferably comprises less than about ¼ inch, preferably about 3/16 inch. Gap 270 preferably allows room to move magnetic wallpaper strip 130 to align portions of printed image 140 spanning seam 150.

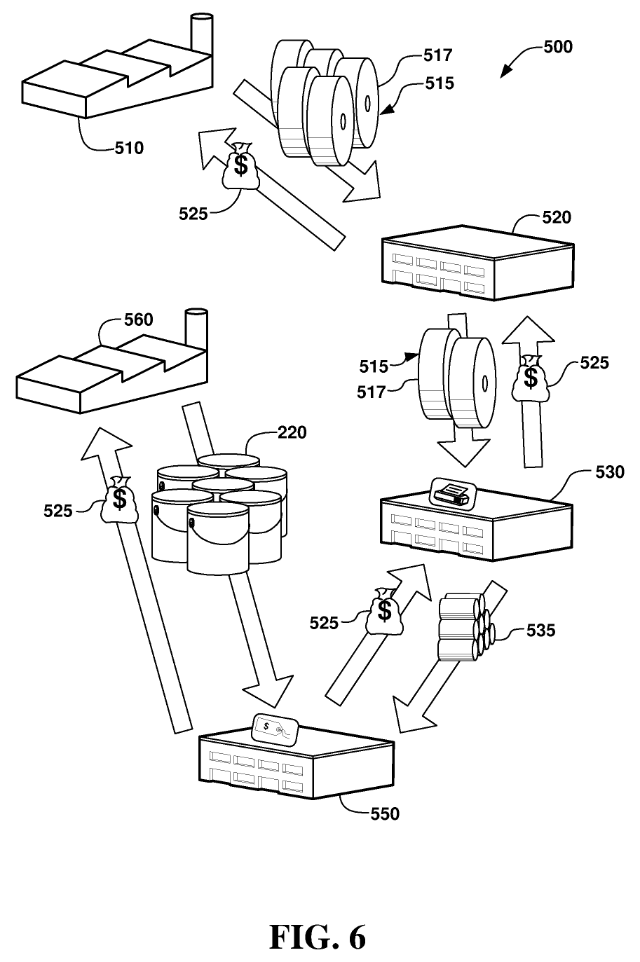

FIG. 6 shows a diagrammatic view illustrating a preferred magnetic wallpaper wholesale supply system 500, comprising product flow to at least one retail distributer 550, according to a preferred embodiment of the present invention. Magnetic laminate manufacturer 510 preferably produces at least one continuous roll 515 preferably comprising magnetic laminate 517, as shown. Magnetic laminate 517 preferably comprises unprinted material suitable to use as magnetic wallpaper strip 130 (see discussion of FIGS. 1-5). Preferably, continuous roll 515 is transferred to at least one wholesale distributer 520 for storage and distribution, as shown. Magnetic laminate manufacturer 510 preferably receives compensation 525, for magnetic laminate 517, from wholesale distributer 520, as shown. Preferably, at least one printing agency 530 provides compensation 525 for such at least one roll 515 of magnetic laminate 517 from wholesale distributer 520. Printing agency 530 preferably prints printed image 140 on magnetic laminate 517, using at least one printer preferably capable of accepting the physical media dimensions of roll 515 of magnetic laminate 517 and preferably cuts magnetic laminate in at least one length appropriate to use as magnetic wallpaper strip 130. Preferably, such at least one printer comprises at least one laser printer. Preferably, such at least one length of printed magnetic laminate comprises magnetic wallpaper strip 130. When desired by printing agency 530, magnetic laminate 517 may be magnetized after printing, particularly when magnetic fields may disrupt the proper operation of the printer used. Preferably, magnetic wallpaper strip 130 is rolled, forming roll 280, and preferably shipped to retail distributer 550, as shown. Retail distributer 550 preferably renders compensation 525 to printing agency 530, as shown. Similarly, retail distributer 550 preferably obtains magnetically attractive paint 220 preferably from magnetic paint manufacturer 560 for suitable compensation 525, as shown. Compensation 525 preferably comprises at least one monetary value approximately equivalent to the value of the goods or the services obtained in exchange. Upon reading this specification, those with ordinary skill in the art will now appreciate that, under appropriate circumstances, considering such issues as design preference, user preferences, marketing preferences, cost, structural requirements, available materials, technological advances, etc., other sizing arrangements such as, for example, portions other than rolls, etc., may suffice.

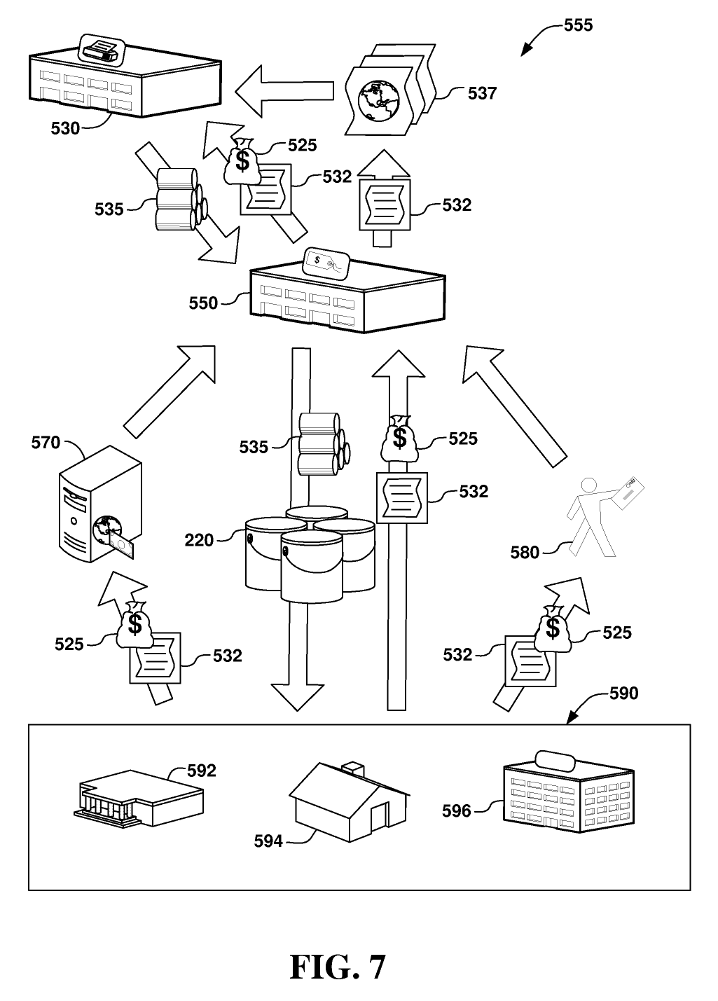

FIG. 7 shows a diagrammatic view illustrating a preferred magnetic wallpaper retail sales system 555, comprising retail distribution to at least one customer 590, according to a preferred embodiment of the present invention. Customer 590 comprises preferably at least one organization 592, alternately preferably at least one resident 594, alternately preferably at least one business 596, as shown. As shown, customer 590 preferably purchases magnetically-attractive paint 220 and rolls 535 of magnetic wallpaper strips 130 from retail distributer 550. For additional compensation 525, customer may preferably place at least one custom order 532, as shown, with retail distributer 550. Retail distributer 550 preferably passes custom order 532 to printing agency 530, as shown. Alternately preferably, custom order 532 may be placed via at least one website 537, as shown, affiliated with printing agency 530. Printing agency 530 preferably completes custom order 532 and preferably ships custom printed rolls 536 of magnetic wallpaper strips 130, as shown. Custom order 532 comprises preferably at least one custom size, alternately preferably at least one custom printed image. Customer preferably makes purchases, as shown, directly from retail distributer 550, alternately preferably through at least one e-commerce website 570 of retail distributer 550, alternately preferably through at least one mail-order catalog 580 of retail distributer 550. After obtaining magnetic wallpaper strips 130, customer may preferably install magnetic wall covering 110.

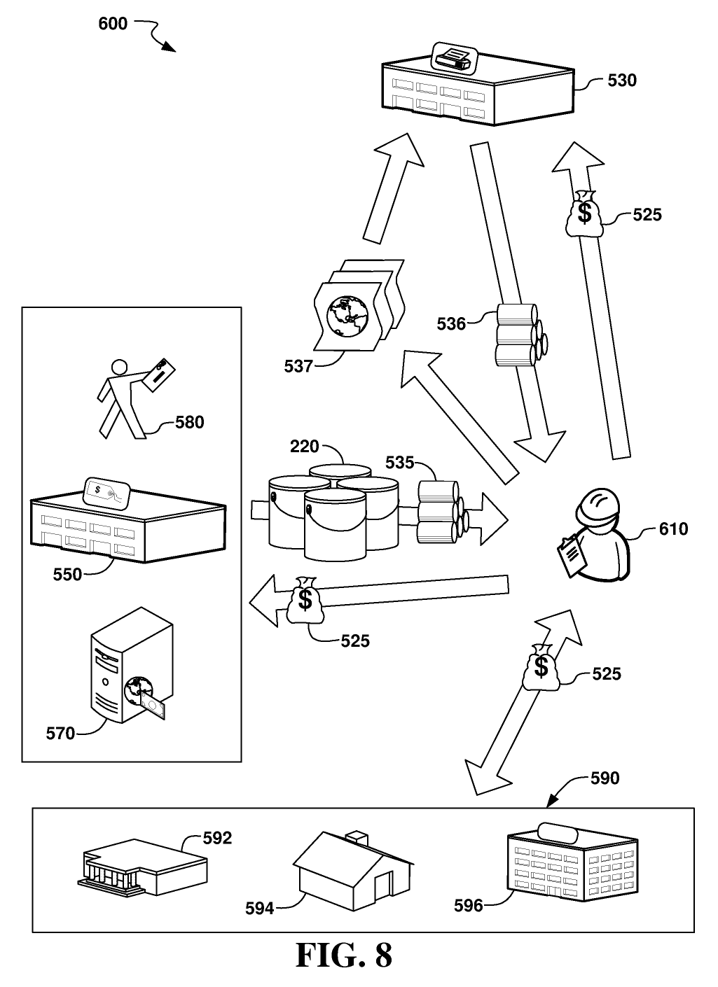

FIG. 8 shows a diagrammatic view illustrating a preferred magnetic wallpaper product and services system 600, comprising professional services interaction with product flow, according to a preferred embodiment of the present invention. Customer 590 may preferably choose to obtain professional services from at least one contractor 610. As shown, contractor 610 preferably handles the details regarding obtaining materials and installing magnetic wall covering 110. Contractor preferably may obtain magnetically attractive paint 220 and rolls 535 of magnetic wallpaper strips 130 from retail distributer 550, alternately preferably through mail-order catalog 580, alternately preferably through e-commerce website 570, as shown. Contractor 610 may also preferably obtain custom rolls 536 of magnetic wallpaper strips 130 from printing agency 530, as shown.

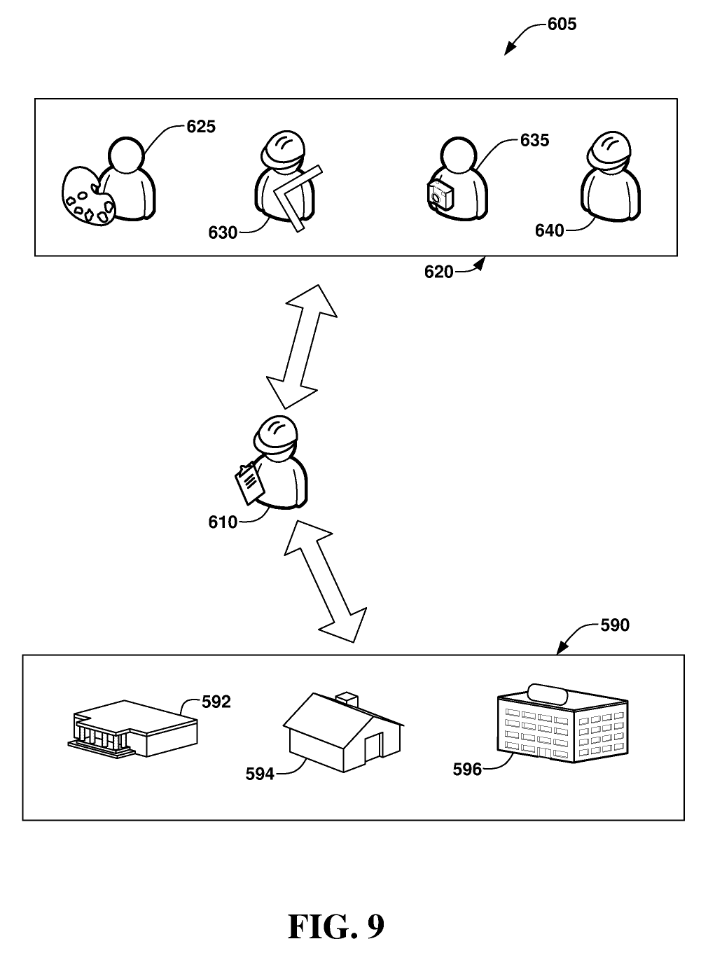

FIG. 9 shows a diagrammatic view illustrating a preferred magnetic wallpaper professional services system 605, illustrating contracted professional services, according to a preferred embodiment of the present invention. Contractor preferably provides professional services, preferably comprising professional service providers 620, to customer 590, as shown. Professional service providers 620 preferably comprise employees of contractor 610, alternately preferably subcontractors to contractor 610. Professional service providers comprise preferably at least one artist 625, alternately preferably at least one architect 630, alternately preferably at least one photographer 635, alternately preferably at least one installer 640, as shown. Preferably, artist 625 comprises at least one graphic artist. Preferably, artist 625 provides professional artistic design services. Preferably architect 630 provides professional architectural design services. Preferably, photographer 635 provides custom photographing services. Professional services providers 620 preferably aid in the customization of magnetic wall covering 110 (at least embodying herein wall-covering means for substantially covering at least one portion of at least one wall). Such customization comprises preferably at least one custom photo, alternately preferably at least one custom graphic art, alternately preferably at least one custom indicia. Preferably, such customization may follow at least one family theme, alternately preferably at least one seasonal theme, alternately preferably at least one educational theme.

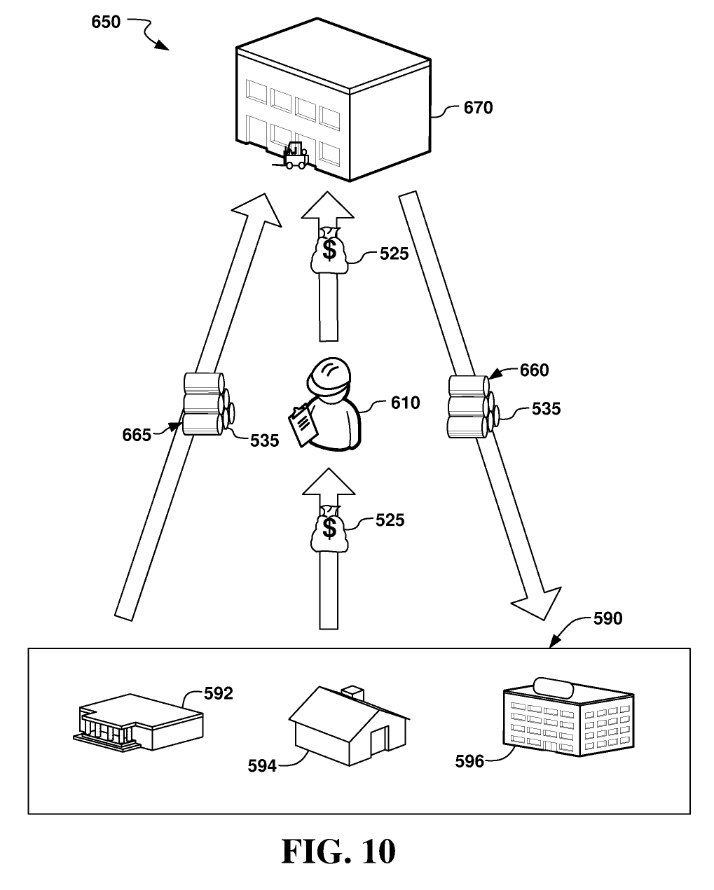

FIG. 10 shows a diagrammatic view illustrating a preferred magnetic wallpaper rotation system 650, comprising wall covering rotation services, according to a preferred embodiment of the present invention. Contractor 610 preferably provides wall covering rotation services preferably comprising: removal services for rotated-out wall covering 665; installation services for rotated-in wall covering 660; and storage services at storage warehouse 670 for unused wall coverings, as shown. Wall covering rotation system 650 preferably comprises rotation following at least one theme.

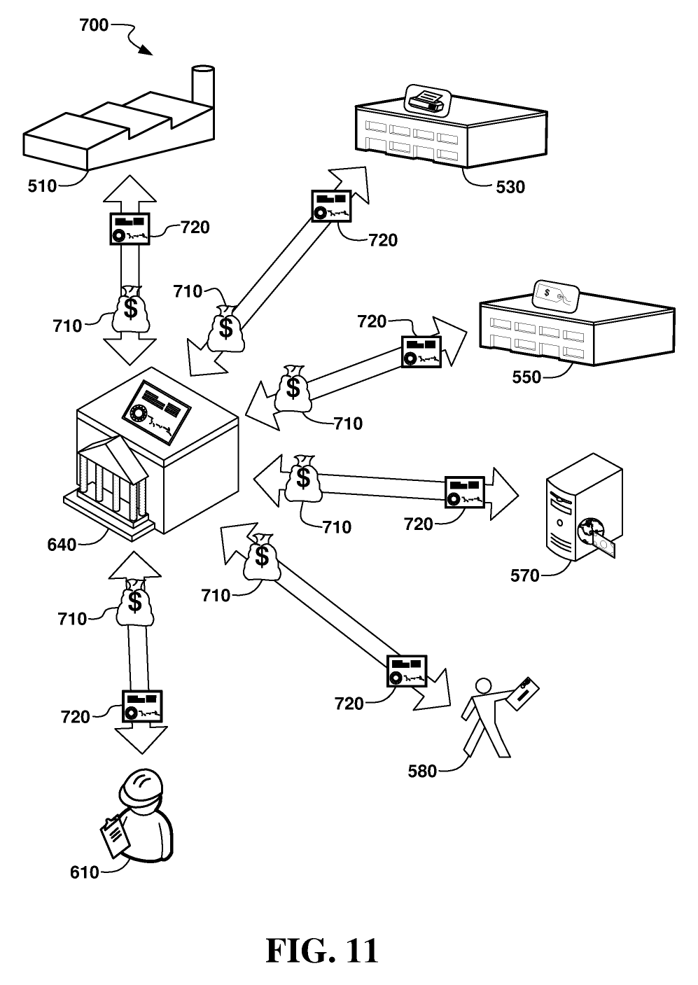

FIG. 11 shows a diagrammatic view illustrating a preferred magnetic wallpaper licensing agreement system 700 according to a preferred embodiment of the present invention. At least one licensor 730 preferably grants at least one license 720 in exchange for at least one licensing fee 710, as shown. Magnetic laminate manufacturer 510 preferably obtains license 720 granting manufacturing. Printing agency 530 preferably obtains license 720 granting rights to print magnetic wallpaper strips 130. License 720 for retail distributer 550, e-commerce website 570 and mail-order catalog 580 preferably grants reseller rights within each respective mode of retail sales. Preferably, license 720 for contractor 610 grants servicing rights based on the capacity of contractor 610 to provide services. Preferably, licensing fee 710 comprises at least one set amount for each product sold or service rendered by the licensee. Alternately preferably, licensing fee 710 comprises at least one fixed fee for at least one specified time period.

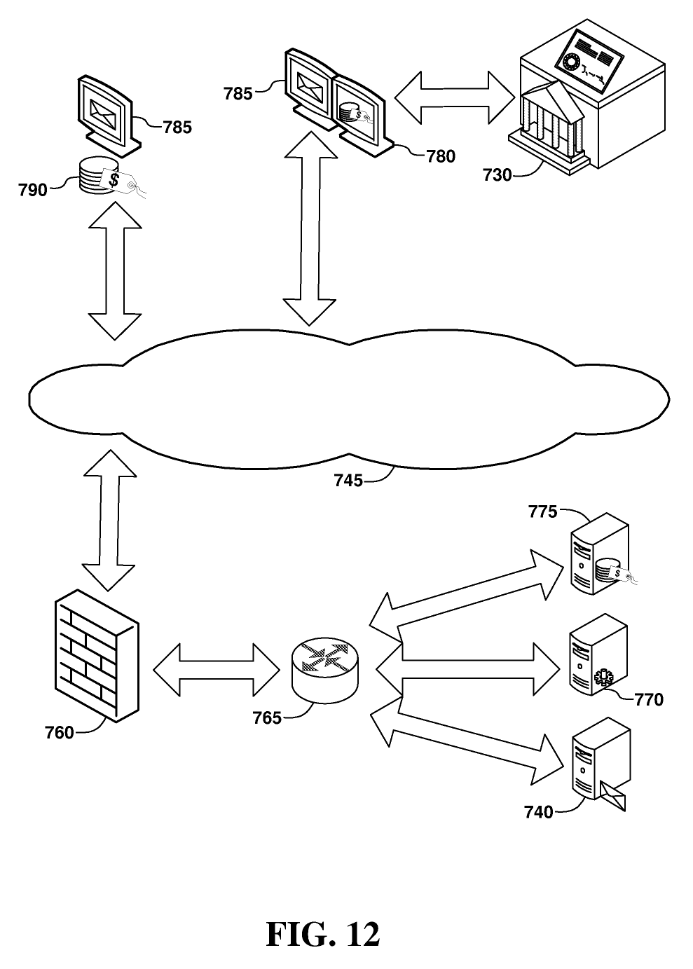

FIG. 12 shows a diagrammatic view illustrating a preferred magnetic wallpaper data processing system 750, illustrating processing and reporting of sales data 790, according to a preferred embodiment of the present invention. At least one sales database server 775 preferably collects sales data 790 through an interconnected network, preferably the internet 745, as shown. At least one application server 770 preferably processes sales data 790 and preferably compiles at least one report 780 on sales. At least one messaging server 740 preferably provides messaging services between licensor 730 and licensees. Application server 770, sales database server 775 and messaging server 740 are preferably connected to the Internet 745 preferably through at least one firewall 760 and are preferably networked together through at least one router 765, as shown. Licensor 730 preferably receives report 780 and preferably connects to messaging server 740 through at least one network enabled device, preferably at least one personal computer 785. Preferably, licensor 730 uses report 780 to aid in determining licensing fee 710. Licensor 730 preferably uses messaging server 740

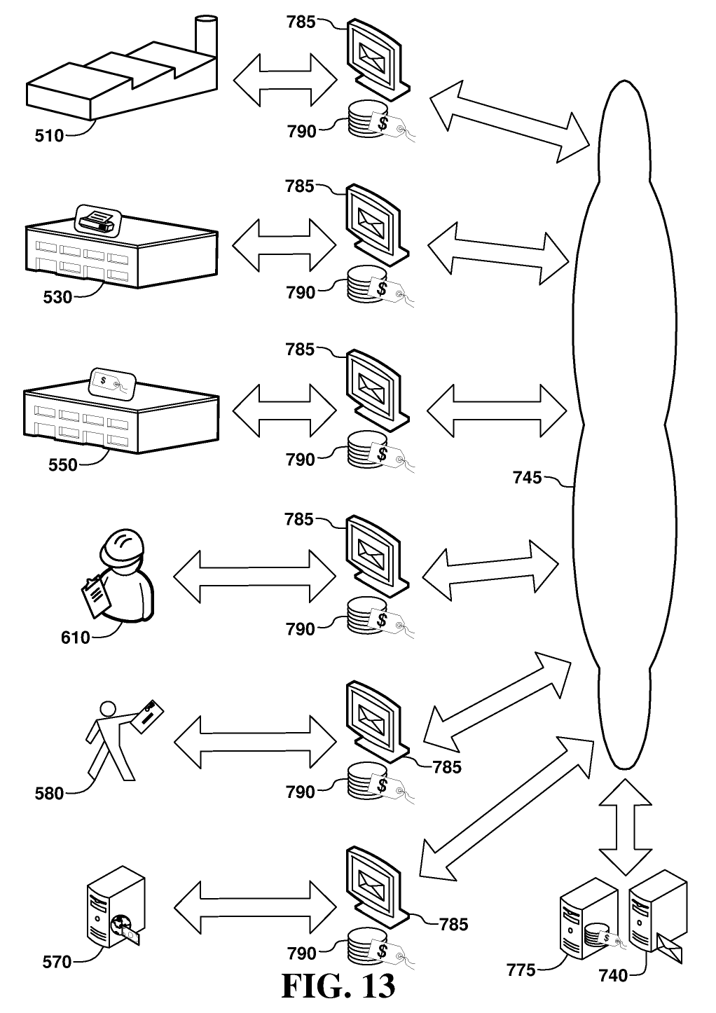

FIG. 13 shows a diagrammatic view illustrating a preferred information exchange system 800, illustrating messaging and exchange of sales data 790, according to a preferred embodiment of the present invention. Magnetic laminate manufacturer 510, printing agency 530, retail distributer 550, e-commerce website 570, mail-order catalog 580, and contractor 610 preferably each maintain at least one database of sales data 790, as shown. Preferably, sales data 790 is transmitted via Internet 745 to sales database server 775, as shown. Likewise, each licensee preferably connects to messaging server 740 to send and receive messages through at least one network enabled device, preferably at least one personal computer 785, as shown.

Although applicant has described applicant's preferred embodiments of this invention, it will be understood that the broadest scope of this invention includes modifications such as diverse shapes, sizes, and materials. Such scope is limited only by the below claims as read in connection with the above specification. Further, many other advantages of applicant's invention will be apparent to those skilled in the art from the above descriptions and the below claims.

What is claimed is:

1) A method, relating to covering building walls and related essentially flat surfaces using rolls of flexible wall-coverings, comprising the steps of:
a) unrolling and cutting strips of such wall-coverings;
b) securely attaching such cut strips, in a non-wetted condition, to respective portions of surfaces to be covered;
c) wherein such strips may be unattached from such surfaces without harm to such strips and such surfaces.

2) The method according to claim 1, wherein such attached strips may be moved after being so unattached and re-used on another such surfaces.

3) The method according to claim 1, further comprising the step of magnetically preparing respective portions of surfaces to be covered with magnetic paint; wherein such strips of such wall-coverings comprise at least one magnetic material.

4) The method according to claim 2, further comprising the step of magnetically preparing respective portions of surfaces to be covered with magnetic paint; wherein such strips of such wall-coverings comprise at least one magnetic material.

5) A method, relating to covering building walls and related essentially flat surfaces, comprising the step(s) of:
a) providing at least one plurality of adjoinable, flexible, wall-covering strips; and
b) securely attaching, in an adjoining relation, at least two such wall-covering strips, in a non-wetted condition, to respective portions of surfaces to be covered.

6) The method according to claim 5, further comprising the step(s) of removing such at least two such wall-covering strips, also in a non-wetted condition without harm to such at least two wall-covering strips and such surfaces.

7) The method according to claim 6, further comprising the step of magnetically preparing respective portions of surfaces to be covered with magnetic paint; wherein such wall-covering strips comprise at least one magnetic material.

8) The method according to claim 7, further comprising the step of magnetically preparing respective portions of surfaces to be covered with magnetic paint; wherein such wall-covering strips comprise at least one magnetic material.

9) A method, relating to covering building walls and related essentially flat surfaces, comprising the steps of:
a) providing magnetically preparing respective portions of surfaces to be covered;
b) providing at least one plurality of magnetic, flexible, wall-covering strips wherein such strips may be magnetically attached to such surfaces to be covered; and
c) securely attaching, in an adjoining relation, at least two such wall-covering strips, in a non-wetted condition, to respective portions of surfaces to be covered.

10) A wall-covering system, relating to covering at least one portion of at least one wall, said system comprising:
a) at least one plurality of flexible-material, wall-covering strips adjoined to cover at least one substantial portion of such at least one wall; and
b) at least one releasable attachment system positioned immediately adjacent such at least one substantial portion of such at least one wall;
c) wherein said releasable attachment system is structured and arranged to permit non-destructive removal of such wall-covering strips from such at least one portion of such at least one wall.

11) The wall-covering system according to claim 10, wherein such removed wall-covering strips are structured and arranged to be re-used.

12) The wall-covering system according to claim 11, wherein such wall-covering strips comprise at least one printable surface.

13) The wall-covering system according to claim 12, wherein said at least one printable surface comprises printed photography.

14) The wall-covering system according to claim 12, wherein said at least one printable surface comprises printed art.

15) The wall-covering system according to claim 11, wherein said at least one printable surface comprises at least one portion of at least one serial theme.

16) The wall-covering system according to claim 15, wherein said at least one serial theme relates to at least one of the group consisting essentially of:
a) at least one convention;
b) at least one holiday;
c) at least one season;
d) at least one celebration;
e) at least one event;
f) at least one honoring of at least one individual;
g) at least one honoring of at least one relationship;
h) at least one educational theme;
i) at least one advertisement.

17) The wall-covering system according to claim 10, wherein said at least one wall-covering is attachable to at least one magnetically prepared wall.

18) The wall-covering system according to claim 10, wherein said at least one wall cover is cut from a roll of flexible material.

19) The wall-covering system according to claim 10, further comprising the at least one portion of at least one wall;
wherein said at least one portion of at least one wall is covered using wall-coverings comprising at least one printed surface; said printed surface comprising at least one portion of at least one serial theme.

20) A method of wallpapering at least one portion of at least one wall comprising the step(s) of:
a) providing materials to magnetically prepare such at least one portion of at least one wall;
b) providing at least one wall cover comprising at least one releasable attachment system to attach such at least one wall cover to such magnetically prepared at least one portion of at least one wall;
c) attaching such at least one wall cover to such at least one magnetically prepared at least one portion of at least one wall.

21) The method according to claim 20, wherein the step of providing at least one wall cover comprises the step(s) of providing selecting at least one image to be printed on such at least one wall cover.

22) The method according to claim 21, wherein the step of providing at least one wall cover further comprises the step(s) of providing assisting renting such at least one wall cover.

23) The method according to claim 21, wherein the step of providing selecting at least one image to be printed on such at least one wall cover comprises the step(s) of providing assisting printing at least one advertisement on such at least one wall cover.

24) A wall-covering system, relating to covering at least one portion of at least one wall, said system comprising:
a) wall-covering means for substantially covering at least one portion of at least one wall;
b) wherein said wall-covering means comprises attaching means for attaching said wall-covering means to such at least one portion of at least one wall;
c) wherein said attaching means comprises releaser means for releasing said wall-covering means from such at least one portion of at least one wall; and
d) wherein said attaching means are substantially retained even after said wall-covering means is released from such at least one portion of at least one wall.

25) A wall-covering system, relating to covering at least one portion of at least one wall, said system comprising:
a) at least one wall cover to cover at least one portion of at least one wall;
b) wherein said at least one wall cover comprises at least one attacher to attach said wall cover to such at least one portion of at least one wall;
c) wherein said attacher comprises at least one releaser to release said wall cover from such at least one portion of at least one wall; and
d) wherein said attacher is substantially retained even after said wall cover is released from such at least one portion of at least one wall.

26) The method according to claim 1, wherein such wall-covering comprises at least one printable surface.

27) The method according to claim 26, wherein such at least one printable surface comprises printed photography.

28) The method according to claim 26, wherein such at least one printable surface comprises printed art.

29) The method according to claim 26, wherein such at least one printable surface comprises at least one portion of at least one serial theme.

30) The method according to claim 29, wherein such at least one serial theme relates to at least one of the group consisting essentially of:
a) at least one convention;
b) at least one holiday;
c) at least one season;
d) at least one celebration;
e) at least one event;
f) at least one honoring of at least one individual;
g) at least one honoring of at least one relationship;
h) at least one educational theme;
i) at least one advertisement.

31) The system according to claim 10, wherein said flexible-material, wall-covering strips comprise at least one sheet magnet layer less than about 20 mil.

32) The system according to claim 10, wherein said flexible-material, wall-covering strips comprise at least one sheet magnet layer less than about 15 mil in thickness.
